(19) United States
(12) Patent Application Publication
(10) Pub. No.: US 2019/0249665 A1
(43) Pub. Date: Aug. 15, 2019

(54) System for a Utility Vehicle Comprising a Compressor and an Electric Motor

(71) Applicant: KNORR-BREMSE Systeme fuer Nutzfahrzeuge GmbH, Muenchen (DE)

(72) Inventors: Peter KOVACSIK, Muenchen (DE); Huba NEMETH, Muenchen (DE); Viktor TIHANYI, Muenchen (DE)

(21) Appl. No.: 16/331,089

(22) PCT Filed: Sep. 19, 2017
(86) PCT No.: PCT/EP2017/073552

§ 371 Date: Apr. 26, 2019

(30) Foreign Application Priority Data
Sep. 21, 2016 (DE) 10 2016 011 504.1

(51) Int. Cl. F04C 23/02; F04C 29/02; B60T 17/02

(52) U.S. Cl. CPC F04C 23/02; B60T 17/02; F04C 29/02

(57) ABSTRACT

A system for a utility vehicle has a compressor, an electric motor and an electronic drive system. The electric motor drives the compressor. The electric motor and the electronic drive system have a common housing. The electric motor has a rotor which at least partially surrounds the drive shaft of the compressor.

### BACKGROUND AND SUMMARY OF THE INVENTION

The present invention relates to a system for a utility vehicle, comprising a screw compressor and an electric motor.

Screw compressors for utility vehicles are already known from the prior art. Screw compressors of this type are used to provide the necessary compressed air for the brake system of the utility vehicle, for example.

In this connection, in particular oil-filled compressors, in particular also screw compressors, are known in which it is the object to regulate the oil temperature. This is generally brought about by the fact that there is an external oil cooler which is connected to the oil-filled compressor and the oil circuit via a thermostatic valve. The oil cooler here is a heat exchanger which has two circuits which are separated from each other, wherein the first circuit is provided for the hot liquid, i.e. the compressor oil, and the second for the cooling liquid. The cooling liquid used can be, for example, air, water mixtures with antifreeze or with another oil.

This oil cooler then has to be connected to the compressor oil circuit via pipes or hoses, and the oil circuit has to be secured against leakages.

Furthermore, this external volume has to be filled with oil, and therefore the overall quantity of oil is also increased. This increases the system inertia. Furthermore, the oil cooler has to be mechanically accommodated and fastened, either by holders located lying there around or by a separate holder, which requires additional fastening means, but also construction space.

A screw compressor with integrated oil cooling is already known from U.S. Pat. No. 4,780,061.

Furthermore, DE 37 17 493 A1 discloses a screw compressor system which is arranged in a compact housing and has an oil cooler on the electric motor of the screw compressor.

A compressor flange for a screw compressor is known from DE 10 2010 015 151 A1.

Furthermore, a connecting flange for a heat exchanger of a motor vehicle, the connecting flange having cooling ducts, is known from US 2014/0190674 A1.

Furthermore, a heat exchanger with a flange connection is known from DE 10 2013 011 061 B3, wherein the flange connection has a connection flange which is a die cast part and has through-holes produced by casting for receiving screw bolts.

A dry-running compressor, in which an electric motor is integrated, is known from WO 2009/033556 A1.

A comparable arrangement is also known from CN 102748292 A.

It is the object of the present invention to develop a system for a utility vehicle, comprising a compressor, an electric motor and an electronic drive unit of the type mentioned at the beginning in an advantageous manner, in particular to the effect that the space required by such a system can be reduced further.

This object is achieved according to the invention by a system for a utility vehicle which comprises a compressor, an electric motor and an electronic drive unit, wherein the electric motor and the electronic drive unit have a common housing, and wherein the electric motor has a rotor which at least partially engages around the drive shaft of the compressor.

The invention is based on the basic concept of producing a common constructional unit for the electric motor, compressor and electronic drive unit, and therefore overall a compact constructional unit for the system can arise. It is thereby possible to reduce the overall axial length of the entire unit. In particular by the electronic drive unit being integrated at the same time in the housing of the electric motor, it is possible to be able to construct same more compactly.

The compressor can be a screw compressor. The configuration in the form of a screw compressor enables efficient and economical operation of the compressor within the scope of generating compressed air for a utility vehicle, in particular in connection with hybrid utility vehicles. In the case of vehicles of this type, the situation is in particular to the effect that the drive unit of the utility vehicle does not operate continuously in the driving mode and therefore driving of the compressor by means of the drive unit is not always possible. A decoupling is therefore necessary, and therefore the use of screw compressors is of advantage.

The electronic drive unit can be arranged on that side of the electric motor which faces away from the compressor. It is thereby possible to arrange the components of the system substantially along an axis and to thereby also be able to optimally use the construction space.

The electric motor can have a drive shaft with which the compressor is driven, and it can be provided that the electronic drive unit is arranged radially with respect to the drive shaft. By means of an arrangement of this type, it is possible also to use construction space available in the radial direction with respect to the drive shaft for components of the system.

In principle, however, it is also possible that the electronic drive unit is arranged axially with respect to the drive shaft. Depending on the configuration, corresponding construction space which can be used is also available here.

The electric motor can have a stator with windings spaced apart from one another, wherein the electronic drive unit partially projects into intermediate spaces between the windings. It is thereby possible also to use these intermediate spaces as construction space for the electronic drive unit. A compact design of the entire unit is thereby further improved and made possible.

Further details and advantages of the invention will now be explained in more detail with reference to an exemplary embodiment which is illustrated in the drawings.

### BRIEF DESCRIPTION OF THE DRAWINGS

FIG. 1 shows a schematic sectional illustration of an exemplary embodiment according to the invention for a system according to the invention for a utility vehicle, comprising a screw compressor and an electric motor;

FIG. 2 shows a perspective exploded drawing of the components of an exemplary embodiment according to the invention of the system; and

FIG. 3 shows a perspective detailed sectional drawing through the electric motor and the electronic drive unit of the electric motor of the system according to FIG. 2.

### DETAILED DESCRIPTION OF THE DRAWINGS

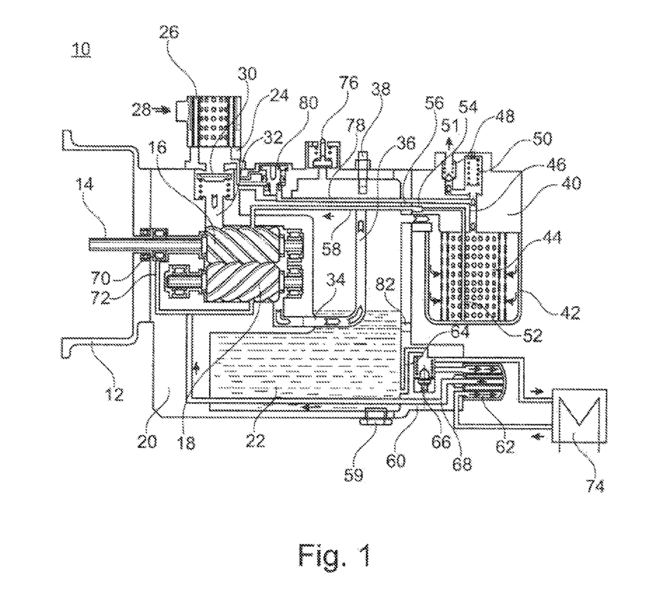

FIG. 1 shows, in a schematic sectional illustration, a screw compressor 10 within the meaning of an exemplary embodiment for the present invention.

The screw compressor 10 has a fastening flange 12 for mechanically fastening the screw compressor 10 to an electric motor (not shown specifically here).

However, the input shaft 14 via which the torque is transmitted from the electric motor to one of the two screws 16 and 18, namely the screw 16, is shown. The screw 18 meshes with the screw 16 and is driven by the latter.

The screw compressor 10 has a housing 20 in which the essential components of the screw compressor 10 are accommodated.

The housing 20 is filled with oil 22.

On the air input side, an inlet stub 24 is provided on the housing 20 of the screw compressor 10. The inlet stub 24 is designed here in such a manner that an air filter 26 is arranged thereon. In addition, an air inlet 28 is provided radially on the air inlet stub 24.

A spring-loaded valve insert 30, designed here in the form of an axial seal, is provided in the region between the inlet stub 24 and the point at which the inlet stub 24 is attached to the housing 20.

This valve insert 30 serves as a nonreturn valve.

An air supply duct 32 which supplies the air to the two screws 16, 18 is provided downstream of the valve insert 30.

An air outlet tube 34 with a riser 36 is provided on the output side of the two screws 16, 18.

A temperature sensor 38 by means of which the oil temperature can be monitored is provided in the region of the end of the riser 36.

A holder 40 for an air-deoiling element 42 is furthermore provided in the air outlet region.

In the mounted state, the holder 40 for the air-deoiling element has the air-deoiling element 42 in the region facing the ground (as also shown in FIG. 1).

A corresponding filter sieve or known filter and oil separator devices 44, which are not specified more specifically in detail, is or are furthermore provided in the interior of the air-deoiling element 42.

In the central upper region, with reference to the mounted and operationally ready state (i.e. as shown in FIG. 1), the holder for the air-deoiling element 42 has an air output opening 46 which leads to a nonreturn valve 48 and a minimum pressure valve 50. The nonreturn valve 48 and the minimum pressure valve 50 can also be formed in a common combined valve.

The air outlet 51 is provided downstream of the nonreturn valve 48.

The air outlet 51 is generally connected to correspondingly known compressed air consumers.

In order to return the separated oil 22 located in the air-deoiling element 42 back into the housing 20, a riser 52 is provided which has a filtering and nonreturn valve 54 at the output of the holder 40 for the air-deoiling element 42 upon passage into the housing 20.

A nozzle 56 is provided in a housing bore downstream of the filtering and nonreturn valve 54. The oil-recycling line 58 leads back into approximately the central region of the screw 16 or of the screw 18 in order to supply oil 22 thereto again.

An oil drain screw 59 is provided in the bottom region of the housing 20 in the mounted state. Via the oil drain screw 59, a corresponding oil discharge opening can be opened, via which the oil 22 can be let out.

In the lower region of the housing 20 there is also a lug 60 to which the oil filter 62 is fastened. The oil 22 is first of all conducted to a thermostatic valve 66 via an oil filter inlet duct 64 which is arranged in the housing 20.

Instead of the thermostatic valve 66, it is possible to provide a control and/or regulating device, by means of which the oil temperature of the oil 22 located in the housing 20 can be monitored and can be set to a desired value.

The oil inlet of the oil filter 62 is then downstream of thermostatic valve 66, said oil inlet conducting the oil 22 via a central return line 68 back again to the screw 18 or to the screw 16, but also to the oil-lubricated bearing 70 of the shaft 14. A nozzle 72 which is provided in the housing 20 in conjunction with the return line 68 is also provided in the region of the bearing 70.

The cooler 74 is connected to the lug 60.

A safety valve 76 via which too great a pressure in the housing 20 can be dissipated is located in the upper region of the housing 20 (with reference to the mounted state).

A bypass line 78 leading to a relief valve 80 is located upstream of the minimum pressure valve 50. Via said relief valve 80, which is activated by means of a connection to the air supply 32, air can be returned into the region of the air inlet 28. In this region, a venting valve (not shown specifically) and also a nozzle (reduction in diameter of the supplying line) can be provided.

Furthermore, an oil level sensor 82 can be provided approximately level with the line 34 in the outer wall of the housing 20. Said oil level sensor 82 can be, for example, an optical sensor and can be produced and designed in such a manner that it can be identified on the basis of the sensor signal whether the oil level during operation is above the oil level sensor 82 or whether the oil level sensor 82 is exposed and the oil level has thereby correspondingly dropped.

In connection with said monitoring, it is also possible to provide an alarm unit which outputs or transmits a corresponding error message or warning message to the user of the system.

The function of the screw compressor 10 shown in FIG. 1 is as follows.

Air is supplied via the air inlet 28 and passes via the nonreturn valve 30 to the screw 16, 18 where the air is compressed. The compressed air-oil mixture, with a compression factor of between 5 and 16 times, rises downstream of the screws 16 and 18 through the drain line 34 via the riser 36, is blown directly onto the temperature sensor 38.

The air which still partially bears oil particles is then guided via the holder 40 into the air-deoiling element 42 and passes, if the corresponding minimum pressure is reached, into the air drain line 51.

The oil 22 located in the housing 20 is kept at operating temperature via the oil filter 62 and optionally via the heat exchanger 74.

If no cooling is necessary, the heat exchanger 74 is not used and is also not switched on.

The corresponding switching on takes place via the thermostatic valve 66. After the purification in the oil filter 62, oil is supplied via the line 68 to the screw 18 or to the screw 16, but also to the bearing 70. The screw 16 or the screw 18 is supplied with oil 22 via the return line 52, 58; the purification of the oil 22 takes place here in the oil-deoiling element 42.

The screws 16 and 18 of the screw compressor 10 are driven via the electric motor (not shown specifically) which transmits its torque via the shaft 14 to the screw 16 which, in turn, meshes with the screw 18.

It is ensured via the relief valve 80 (not shown specifically) that, in the region of the feed line 32, the high pressure prevailing in the operating state, for example on the output side of the screws 16, 18, cannot be confined, but rather that, in particular during starting of the compressor, there is always a low input pressure, in particular atmospheric pressure, in the region of the feed line 32. Otherwise, with starting of the compressor, first of all a very high pressure would arise on the output side of the screws 16 and 18, which pressure would overload the drive motor.

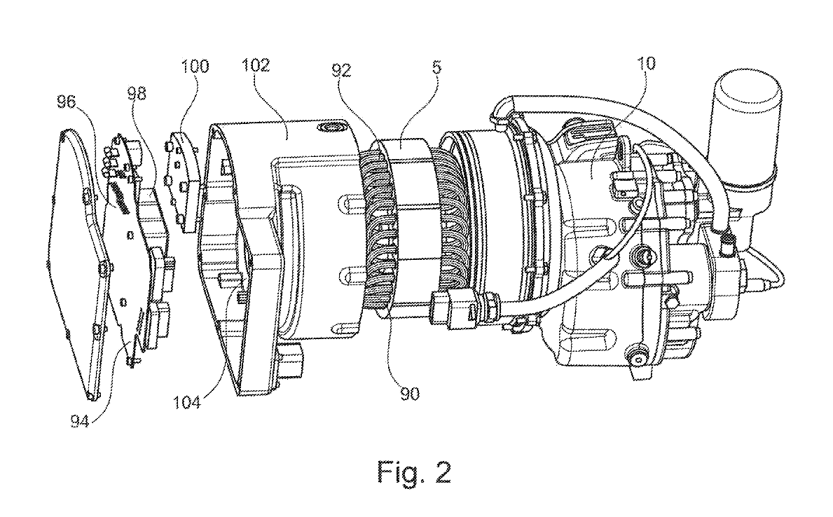

FIG. 2 shows, in a perspective exploded illustration, the system for a utility vehicle.

The system has an electric motor 5 and a screw compressor 10 as shown in FIG. 1.

Further components of the system 1 are the stator 90 of the electric motor 5, which stator has a plurality of windings 92 which are spaced apart from one another. The rotor of the electric motor 5 is not illustrated specifically.

Furthermore, an electronic drive unit 94 is provided.

The electronic drive unit 94 here has a main printed circuit board 96 and capacitive and inductive components 98 and a cooling element 100.

As is already apparent from FIG. 2, the rotor of the electric motor 5 is accommodated by a common housing component or housing 102 on one side and the electronic drive unit 94 is accommodated on the other side.

The housing component 102 has an intermediate wall 104 which separates the electronic drive unit 94 from the rotor.

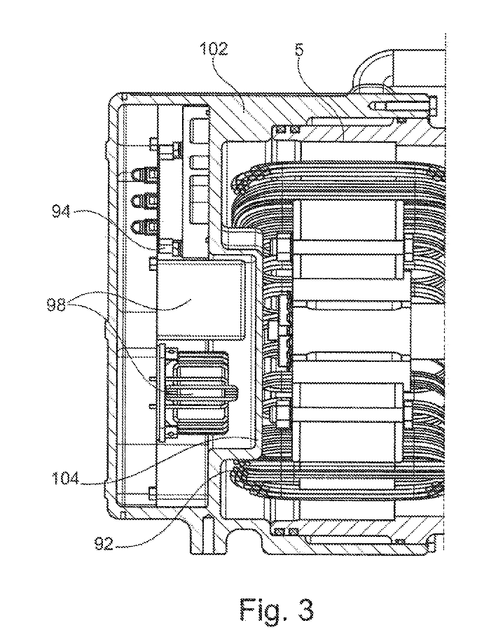

This can be seen particularly readily in the detailed illustration in FIG. 3.

This intermediate wall 104 has a recess which is directed in the direction of the windings 92 of the rotor and into which the capacitive and inductive elements 98, as well as the cooling element 100 of the electronic drive unit 94, project.

By this means, the axial overall length of the entire system 1 can be reduced.

### LIST OF REFERENCE SIGNS

1 System
5 Electric motor
10 Screw compressor
12 Fastening flange
14 Input shaft
16 Screws
18 Screws
20 Housing
22 Oil
24 Inlet stub
26 Air filter
28 Air inlet
30 Valve insert
32 Air supply duct
34 Air outlet tube
36 Riser
38 Temperature sensor
40 Air/oil separator
42 Oil trap
44 Filter sieve or known filtering or oil separator devices
46 Air output opening
48 Check valve
50 Minimum pressure valve
51 Air outlet
52 Riser
54 Filtering and check valve
56 Choke
58 Oil return line
59 Oil drain screw
60 Lug
62 Oil filter
64 Oil filter inlet duct
66 Thermostatic valve
68 Return line
70 Bearing
72 Choke
76 Safety valve
78 Bypass line
80 Relief valve
82 Oil level sensor
90 Stator
92 Windings
94 Electronic drive unit
96 Main printed circuit board
98 Capacitive and inductive component
100 Cooling element
102 Housing component
104 Intermediate wall

1-6. (canceled)

7. A system for a utility vehicle, comprising:
a compressor;
an electric motor; and
an electronic drive unit, wherein
the electric motor drives the compressor,
the electric motor and the electronic drive unit have a common housing, and
the electric motor has a rotor which at least partially engages around a drive shaft of the compressor.

8. The system as claimed in claim 7, wherein
the compressor is a screw compressor.

9. The system as claimed in claim 7, wherein
the electronic drive unit is arranged on that side of the electric motor which faces away from the compressor.

10. The system as claimed in claim 7, wherein
the electric motor has a drive shaft with which the compressor is driven, and
the electronic drive unit is arranged radially with respect to the drive shaft.

11. The system as claimed in claim 9, wherein
the electric motor has a drive shaft with which the compressor is driven, and
the electronic drive unit is arranged axially with respect to the drive shaft.

12. The system as claimed in claim 7, wherein
the electric motor has a stator with windings spaced apart from one another, and
the electronic drive unit partially projects into intermediate spaces between the windings.
